(19) United States
(12) Patent Application Publication
(10) Pub. No.: US 2018/0183204 A1
(43) Pub. Date: Jun. 28, 2018

(54) OPTOFLUIDIC LASER WITH AN ULTRASMALL FABRY-PEROT MICRO-CAVITY

(71) Applicants: Xiang WU, Shanghai (CN); Shusen XIE, Fuzhou (CN); Qijing LU, Fuzhou (CN); Hongqin YANG, Fuzhou (CN)

(72) Inventors: Xiang WU, Shanghai (CN); Shusen XIE, Fuzhou (CN); Qijing LU, Fuzhou (CN); Hongqin YANG, Fuzhou (CN)

(21) Appl. No.: 15/822,707

(22) Filed: Nov. 27, 2017

(30) Foreign Application Priority Data
Dec. 25, 2016 (CN) 2016-11211831.9

(51) Int. Cl. H01S 3/20; H01S 3/02; H01S 3/06; H01S 3/08; G01N 21/64

(52) U.S. Cl. CPC H01S 3/20; H01S 3/022; G01N 21/6456; H01S 3/08059; H01S 3/0627

(57) ABSTRACT

An optofluidic laser with an ultrasmall Fabry-Perot (FB) micro-cavity, This optofluidic laser consists of two highly reflective cavity mirrors and a micro capillary. The two reflective minors are arranged in parallel to form a resonant cavity with an output mirror on the top and a total reflective mirror on the bottom of the cavity. The cavity length L is 30-50 μm, the reflectance of the total reflective mirror is higher than 99.9% and the transmittance of the output mirror is 2%-10%. The capillary, serving as the pathway for the micro fluid, is placed between the two Bragg reflectors. The two ends of the capillary arc connected to Teflon soft tubes. The solution containing either gain medium or biological samples is transported to the FB micro-cavity through the soft tubes. The biological samples pass through the water-soluble or organic liquid gain medium in the micro fluid chamber with a certain speed and, under irradiation of a pumping light, produce high intensity, narrow-band output laser signals. The current invention replaces the traditional fluorescent signals with laser signals as the sensing and imaging medium, to achieve biological sensing with ultra-sensitivity and biological imaging with ultra-resolution.

### RELATED CASE

This application claims priority under 37 C.F.R. 1.55 to Chinese Patent Application No. 2016-11211831.9 filed on Dec. 25, 2016.

### FIELD OF THE INVENTION

The current invention belongs to the field of laser technology. Specifically, it relates to an optofluidic laser with an ultrasmall Fabry-Perot (TB) micro-cavity.

### BACKGROUND OF THE INVENTION

In general, biological fluorescent sensing and imaging are achieved mainly through the fluorescent signals produced by the excitation of fluorescent dyes or proteins on the biological samples. The characteristics of the fluorescent signals, including broad optical spectrum, non-directional emission, high signal noise, and low resolution, prevent biosensing with ultra-sensitivity and optical imaging with ultra-resolution. Micro-optofluidic, micro-cavity laser technology is one of the effective methods to address the above shortcomings in fluorescent imaging. The new laser technology utilizes the fluorescent markers (fluorescent dyes or proteins) on the biological samples (DNA, proteins, or cells) as the gain medium, transported to the micro-cavity through a micro-optofluidic control system and excited to produce laser signals. It replaces the fluorescent signals in the traditional sensing and imaging technologies with laser signals. Compared with the traditional fluorescent techniques, the micro-optofluidic laser technology has the following advantages:
1. High optical coherence, narrow spectrum, and directional emission, easier for signal reception and collection;
2. Low laser signal noise, highly monochromatic, and higher optical resolution than that of fluorescent imaging; and
3. The laser signals have specific thresholds, optical spectrum, optical modes, and other characteristic parameters closely related to the biological properties of the samples. Therefore, unlike the traditional fluorescent techniques, lie characteristic parameters of the laser signals can provide comprehensive information on the structure, conformation, and functionality of the biological samples.

Currently, micro-optofluidic laser technology has been widely used in the areas of high-sensitivity biological sensing, such as the assays for cellular structural changes and the enzyme-linked immunosorbent assay (ELISA). It has generally improved the sensitivity of the current sensing technology. However, the potential of high-resolution imaging of the micro-optofluidic lasers has not been fully explored. This Fabry-Perot type laser can be used for in vitro and in vivo high-resolution biomedical imaging with a resolution less than 100 nm. Specifically, for tumor cells, due to the modes and spectral characteristics of the cell-generated laser signals, this novel optofluidic laser can be used to analyze and characterize malignancy and subcellular structures of tumor cells as well as the tissue pathological changes.

### SUMMARY OF THE INVENTION

The purpose of this invention is to provide an optofluidic laser with an ultrasmall Fabry-Perot cavity for high-resolution optical imaging.

This novel optofluidic laser combines new micro-optofluidic and micro-cavity technologies to achieve narrow-bandwidth laser output of stimulated emission from in vivo cells and tissue, for optical imaging as well as the acquisition and analysis of the laser spectrum, spatial mode, and other characteristic parameters of biological samples.

The micro-optofluidic laser with an ultrasmall Fabry-Perot micro-cavity in this invention consists of two highly reflective cavity mirrors and a micro capillary, of which the two mirrors are parallel distributed Bragg reflectors (DBRs) to form the resonant cavity (the FB micro-cavity). The top mirror is the output minor (high reflection and low transmission) and the bottom minor is totally reflective. The cavity length L is 30-50 um, the reflectance of the total reflective mirror is higher than 99.9%, and the transmittance of the output mirror is 2%-10%, as shown in FIG. 2. The capillary, either square or rectangular, serving as the pathway for the micro fluid, is placed between two Bragg reflectors and the two ends of the capillary are connected to Teflon soft tubes. The solution containing either gain medium or biological samples is transported to the FB micro-cavity through the soft tubes.

In this invention, the parallelism of the two surfaces of the each DBR is less than or equal to 3″.

In this invention, the parallelism of the surfaces of the total reflective mirror and the output mirror in the cavity is in the range of 5″ to 10″.

In this invention, the material for the two parallel DBRs can be artificial quartz crystal.

In this invention, laser gam medium can be water-soluble organic liquid materials and it can pass through the micro-cavity perpendicularly with a certain speed.

The mechanism this invention is as follows. To achieve the transmission of the optofluidic laser signals in Fabry-Perot micro-cavity with low threshold, the internal loss of the laser signals in the micro-cavity must be low, hence requiring the mirror surfaces of the micro-cavity to have high reflectance. Two DBRs are prepared with a reflectance higher than 99.9% for the total reflective mirror and a transmittance of 2 to 10% for the output mirror. The parallelism of each DBR reached 3″. In the traditional fluorescent sensing and imaging for biological samples, quenching is common. The current invention allows the biological cells or tissue to pass through the micro-fluidic channel with a certain speed, to obtain stable laser signals without fluorescent quenching, hence making the prolonged spectrum analysis feasible.

The current, invention replaces the traditional fluorescent signals with laser signals as the sensing and imaging medium, to achieve biological sensing with ultra-sensitivity and biological imaging with ultra-resolution.

### BRIEF DESCRIPTION OF DRAWINGS

FIG. 1 is the schematic showing the optical platform for this invention. It utilizes a nano-second OPO pumping source (UV-NIH, tunable nano-second laser, 192-600 nm, maximum power 50 mJ/pulse, pulse width 3-5 nm, repetitive rate 10 Hz) and a fluorescent microscope (Olympus BX53).

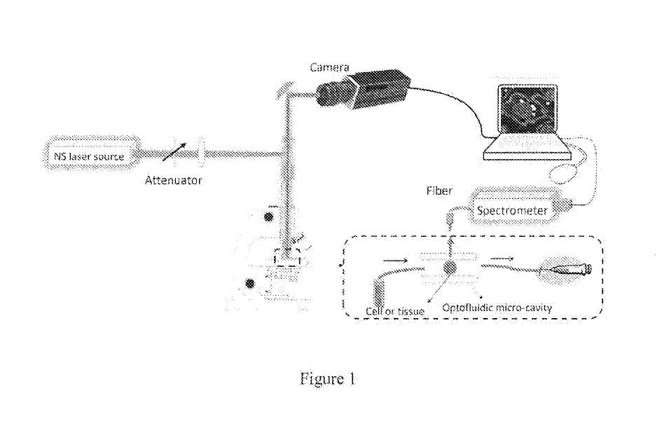

FIG. 2 is the schematic showing the optofluidic micro-cavity.

FIG. 3 shows the laser spectrum from the Fabry-Perot micro-cavity. (a) Laser spectrum from the Fabry-Perot micro-cavity, (b) Spectrum in a narrow wavelength range.

### DETAILED DESCRIPTION OF THE PREFERRED EMBODIMENTS

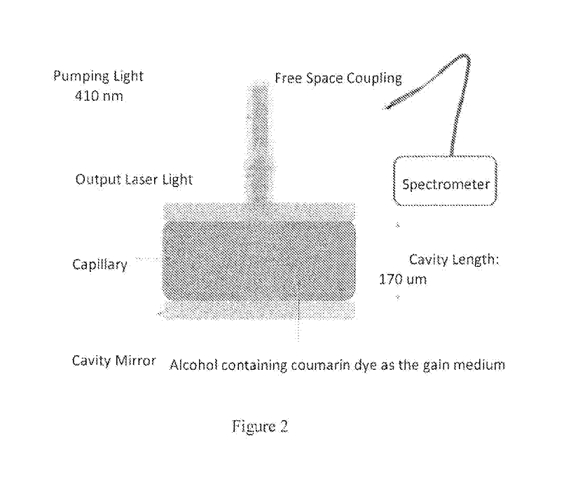

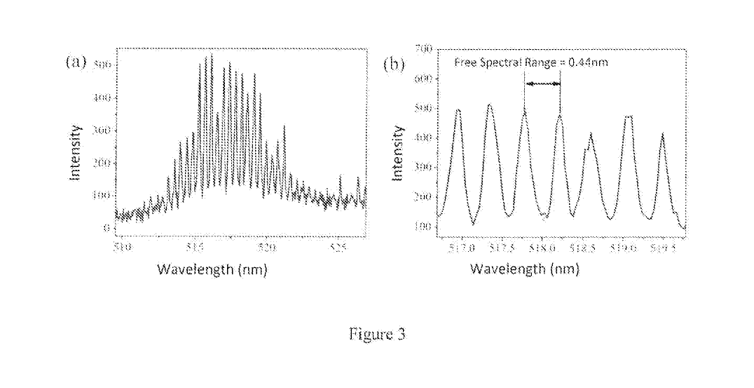

This invention is, further described using the following example: laser pumping experiment with the micro-optofluidic chamber using alcohol containing coumarin dye as the gain medium.
1. Sample Preparation. Fabry-Perot micro-cavity is prepared as shown in FIG. 2. First, place one or two drops of MY131 UV glue on one side of the rectangular capillary and then place the total-reflective mirror on the glue, followed by solidification with UV light. Fix the output mirror on the other side of the capillary following the same procedures. Seal the ends of the two Teflon tubes with the two ends of the capillary using NOA81 to ensure the sample in the micro optofluidic cavity is airtight.
2. Methods of Measurement. First, transport the alcohol solution containing coumarin dye with a micro fluid pump into the micro fluid chamber with a certain speed, using a nano-second OPO laser as the pumping source and a microscope system (Olympus BX53) to focus the light on the top of the micro chamber. The laser signals from the output mirror are collected by a CCD spectrometer and the data are stored and analyzed. As shown in FIG. 3, the laser signals collected by this novel system have excellent periodicity, transmitted in single longitudinal mode, with a free spectral range (FSR) of 0.44 nm.

What is claimed is:

1. An optofluidic laser with an ultrasmall Fabry-Perot micro-cavity, comprising:
two highly reflective cavity mirrors and a micro capillary having two ends, of which the two mirrors are parallel distributed Bragg reflectors (DBRs) to form a resonant cavity with an output mirror on a top and a total reflective mirror on a bottom of the cavity, wherein the cavity has a length L of 30-50 μm, the total reflective mirror has a reflectance of higher than 99.9%, and the output mirror has a transmittance of 2%-10%;
of which the capillary, either square or rectangular, serving as a pathway for a micro fluid, is placed between the two Bragg reflectors, the two ends of the capillary are connected to Teflon soft tubes, and a solution containing either gain medium or biological samples is transported to the Fabry-Perot micro-cavity through the soft tubes.

2. The optofluidic laser with an ultrasmall Fabry-Perot micro-cavity according to claim 1, wherein a parallelism of the two surfaces of the each DBR is less than or equal to 3″.

3. The optofluidic laser with an ultrasmall Fabry-Perot micro-cavity, according to claim 1, wherein a parallelism of the surfaces of the total reflective mirror and the output mirror in the cavity is in the range of 5″ to 10″.

4. The optofluidic laser with an ultrasmall Fabry-Perot micro-cavity, according to claim 1, wherein, the material for the two parallel distributed Bragg reflectors is artificial quartz crystal.
